(19) United States
(12) Patent Application Publication
(10) Pub. No.: US 2010/0315528 A1
(43) Pub. Date: Dec. 16, 2010

(54) DIGITAL PHOTOGRAPHING APPARATUS, METHOD OF CONTROLLING THE SAME, AND COMPUTER READABLE STORAGE MEDIUM HAVING RECORDED THEREON PROGRAM FOR EXECUTING THE METHOD

(75) Inventors: Ji-hyun Goh, Seongnam-si (KR); Sung-cheol Bae, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Electronics Co., Ltd., Suwon-si (KR)

(21) Appl. No.: 12/814,627

(22) Filed: Jun. 14, 2010

(30) Foreign Application Priority Data
Jun. 15, 2009 (KR) 10-2009-0052898

(51) Int. Cl. H04N 5/232; G06K 9/46; H04N 5/228

(52) U.S. Cl. 348/222.1; 348/348; 382/195; 348/E05.031; 348/E05.045

(57) ABSTRACT

A digital photographing apparatus, a method of controlling the same, and a computer readable program product having recorded thereon a program for executing the method. The method of controlling a digital photographing apparatus includes: calculating a distance from the digital photographing apparatus to at least one of a plurality of subject regions; calculating a diaphragm distance by using a focal length calculated based on a diaphragm setting value that indicates a degree of opening of a diaphragm; comparing the distance from the digital photographing apparatus to at least one of a plurality of subject regions with the diaphragm distance; determining whether or not the at least one subject region is in focus, according to the result of comparison; and providing focus information that indicates whether or not the at least one subject region is in focus.

### CROSS-REFERENCE TO RELATED PATENT APPLICATION

This application claims the benefit of Korean Patent Application No. 10-2009-0052898, filed on Jun. 15, 2009, in the Korean Intellectual Property Office, the disclosure of which is incorporated herein in its entirety by reference.

### BACKGROUND

The various embodiments of the invention relate to a digital photographing apparatus, a method of controlling the same, and a computer readable storage medium having recorded thereon a program for executing the method, and more particularly, to a digital photographing apparatus which determines whether or not a subject is properly in focus by using a diaphragm setting value and a distance between the subject to be photographed and the digital photographing apparatus and provides focus information to the user, a method of controlling the same, and a computer readable storage medium having recorded thereon a program for executing the method.

Digital photographing apparatuses photoelectrically convert an optical image of an object into an image signal, perform image processing if necessary, obtain image data from light that is incident on an image pickup unit, and record the image signal in a recording medium or display information about an image photographed by the digital photographing apparatus on a display unit. Such digital photographing apparatuses include a diaphragm that allows a user to adjust the quantity of light incident on the image pickup unit.

The quantity of incident light may be adjusted using an f-number of the diaphragm. Particularly, in the case of a digital single lens reflex (DSLR) camera, a user can adjust the quantity of incident light by manually adjusting the f-number of the diaphragm via a lens adapter. As the f-number of the diaphragm decreases, the degree of opening of the diaphragm increases, and as the f-number of the diaphragm increases, the degree of opening of the diaphragm decreases. Brightness of a photographed image and a depth of field may vary according to the f-number of the diaphragm.

In the case of a conventional digital photographing apparatus, when a user takes a picture, a subject to be photographed is automatically or manually in focus, and setting values for a diaphragm, focusing lens, etc., are adjusted so as to properly focus on the subject. As the f-number of the diaphragm decreases, the depth of field becomes smaller, a focused portion becomes narrower, and other portions become generally out of focus. As the f-number of the diaphragm increases, the depth of field becomes larger, the focused portion becomes wider, and both a subject that is in focus at a short distance and a subject that is in focus at a long distance are clearly photographed.

The user of the conventional digital photographing apparatus may control the f-number of the diaphragm so as to properly focus on the subject. However, an unskilled user who does not know how to operate the digital photographing apparatus may not easily set a setting value, such as an f-number, for use in a photographing operation. Thus, the quality of an image that is photographed when a setting value, such as the f-number, for use in the photographing operation is not appropriately set, may be low.

### SUMMARY

An embodiment of the invention provides a digital photographing apparatus which is capable of indicating to a user both when a subject is properly in focus and when a subject is not properly in focus, a method of controlling the same, and a computer readable storage medium having recorded thereon a program for executing the method.

An embodiment of the invention may also provide a digital photographing apparatus which indicates to a user how to set a diaphragm setting value when a subject to be photographed is not properly in focus, a method of controlling the same, and a computer readable storage medium having recorded thereon a program for executing the method.

An embodiment of the invention may also provide a digital photographing apparatus which determines whether or not a subject is properly in focus by using a diaphragm setting value and a distance between the subject to be photographed and the digital photographing apparatus and provides focus information to a user, a method of controlling the same, and a computer readable storage medium having recorded thereon a program for executing the method.

According to an embodiment of the invention, there is provided a method of controlling a digital photographing apparatus, the method including: calculating a distance from the digital photographing apparatus to at least one of a plurality of subject regions to be photographed; calculating a diaphragm distance by using a focal length calculated based on a diaphragm setting value that indicates a degree of opening of a diaphragm; comparing the distance from the digital photographing apparatus to at least one of a plurality of subject regions with the diaphragm distance; determining whether or not the at least one subject region is properly in focus, according to the result of comparison; and providing focus information that indicates whether or not the at least one subject region is properly in focus.

The method may further include recognizing a face from an input image, wherein the at least one subject region is a region of the face, and the providing of the focus information may include differently displaying a subject region that is properly in focus and a subject region that is not properly in focus.

The method may further include: recognizing at least one of a plurality of faces from input images and displaying at least one facial region; and providing a user interface that allows a user to select the at least one facial region, wherein the at least one subject region is a facial region that is selected by the user.

The method may further include, if the user has selected a facial region and the facial region selected by the user is not properly in focus, calculating a target diaphragm setting value as the diaphragm setting value to be set so as to properly focus on the facial region selected by the user, wherein the providing of the focus information includes, if the facial region selected by the user is properly in focus, providing a message which indicates that the facial region selected by the user is properly in focus, and if the facial region selected by the user is not properly in focus, providing information about the target diaphragm setting value.

Before the comparing of the distance from the digital photographing apparatus to at least one of a plurality of subject regions with the diaphragm distance, the method may further include, if the user has selected a plurality of facial regions: determining whether or not a difference between the distance from the digital photographing apparatus to each of the plurality of subject regions and the diaphragm distance is less than a second threshold value; and calculating an average distance of the distances from the digital photographing apparatus to each of the plurality of subject regions for which the difference with respect to the diaphragm distance is less than the second threshold value, wherein the comparing of the distances from the digital photographing apparatus to each of the plurality of subject regions and the diaphragm distance includes comparing the average distance with the diaphragm distance.

The method may further include providing a subject region designation user interface that allows the user to designate an arbitrary region of the input images as a subject, wherein the at least one subject region is an arbitrary subject region designated by the user.

According to another embodiment of the invention, there is provided a digital photographing apparatus including: a distance calculator that calculates a distance from the digital photographing apparatus to at least one of a plurality of subject regions to be photographed; a diaphragm distance calculator that calculates a diaphragm distance by using a focal length calculated based on a diaphragm setting value that indicates a degree of opening of a diaphragm; a comparator that compares the distance from the digital photographing apparatus to at least one of a plurality of subject regions to be photographed with the diaphragm distance and that calculates a distance comparison result value of a difference between the distance from the digital photographing apparatus to at least one of a plurality of subject regions to be photographed and the diaphragm distance; a focus determination unit that determines whether or not the at least one subject region is properly in focus based on the distance comparison result value; and a focus information provision unit that provides focus information that indicates whether or not the at least one subject region is properly in focus.

According to another embodiment of the invention, there is provided a non-transitory computer readable program product, comprising a computer usable medium having a computer readable program code embodied therein, the computer readable program code adapted to be executed to implement a method of controlling a digital processing apparatus, the method comprising: calculating a distance from a digital photographing apparatus to at least one of a plurality of subject regions; calculating a diaphragm distance by using a focal length calculated based on a diaphragm setting value that indicates a degree of opening of a diaphragm; comparing the distance from a digital photographing apparatus to at least one of a plurality of subject regions with the diaphragm distance; determining whether or not the at least one subject region is properly in focus, according to the result of the comparing; and providing focus information that indicates whether or not the at least one subject region is properly in focus.

### BRIEF DESCRIPTION OF THE DRAWINGS

The above and other features and advantages will become more apparent by describing in detail exemplary embodiments thereof with reference to the attached drawings in which:

FIG. 1 is a block diagram of a digital photographing apparatus according to an embodiment of the invention;

FIG. 2 is a flowchart illustrating a method of controlling the digital photographing apparatus shown in FIG. 1, according to an embodiment of the invention;

FIG. 3A illustrates a screen displayed on a display unit of the digital photographing apparatus of FIG. 1, according to an embodiment of the invention, and FIG. 3B shows distances between the digital photographing apparatus of FIG. 1 and facial regions of subjects to be photographed;

FIG. 4 is a graph of a focal position (step) versus a focus value, for explaining an operation of calculating a distance to a subject to be photographed;

FIG. 5 illustrates a screen displayed on the display unit of the digital photographing apparatus of FIG. 1, according to an embodiment of the invention;

FIGS. 6A through 6C are flowcharts illustrating a method of controlling the digital photographing apparatus of FIG. 1, according to another embodiment of the invention;

FIGS. 7 through 9, FIGS. 10A through 10D, and FIG. 11 respectively illustrate screens displayed on the display unit of the digital photographing apparatus of FIG. 1 when the method of controlling a digital photographing apparatus illustrated in FIG. 2 or FIGS. 6A through 6C is performed;

FIG. 12 shows distances between the digital photographing apparatus of FIG. 1 and each of the facial regions of FIG. 1, for explaining an operation of calculating an average value of distances to the subjects to be photographed;

FIG. 13 is a block diagram of a digital signal processor (DSP) and the display unit of the digital photographing apparatus of FIG. 1, according to an embodiment of the invention; and

FIG. 14 is a block diagram of a DSP, a manipulation unit, and the display unit of the digital photographing apparatus of FIG. 1, according to another embodiment of the invention.

### DETAILED DESCRIPTION OF THE EMBODIMENTS

The attached drawings for illustrating exemplary embodiments of the invention are referred to in order to gain a sufficient understanding of the invention, the merits thereof, and the objectives accomplished by the implementation of the invention. Hereinafter, the invention will be described in detail by explaining exemplary embodiments of the invention with reference to the attached drawings. Like reference numerals in the drawings denote like elements.

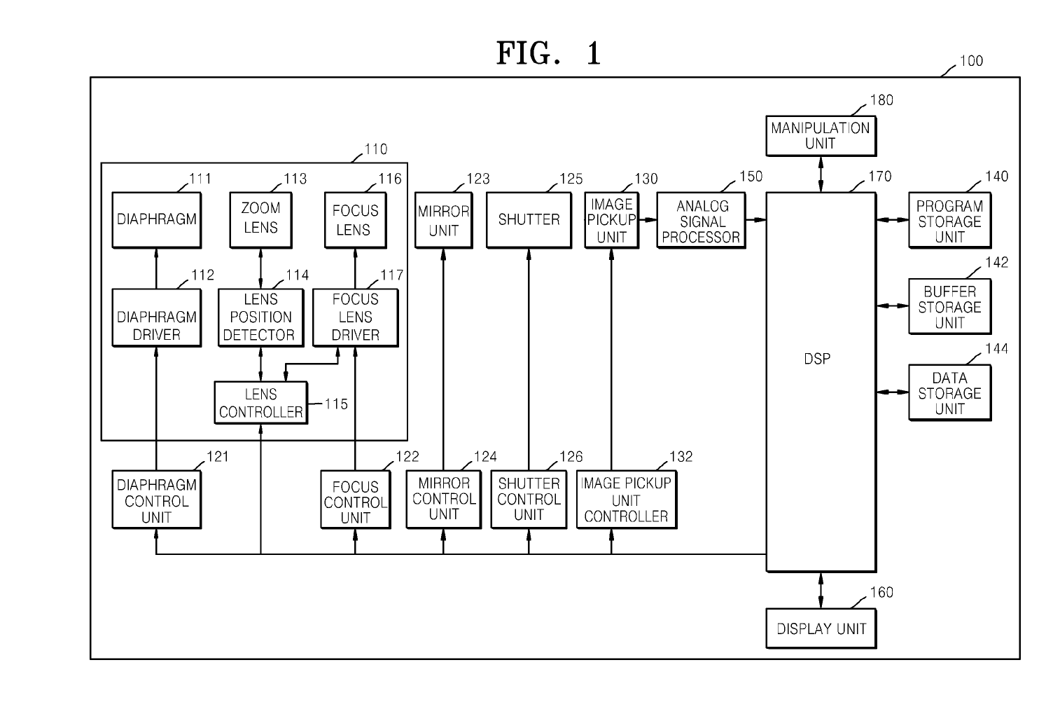

FIG. 1 is a block diagram of a digital photographing apparatus 100 according to an embodiment of the invention. Referring to FIG. 1, the digital photographing apparatus 100 according to the embodiment includes a lens unit 110, a diaphragm control unit 121, a focus control unit 122, a mirror unit 123, a mirror control unit 124, a shutter 125, a shutter control unit 126, an image pickup unit 130, an image pickup unit controller 132, a program storage unit 140, a buffer storage unit 142, a data storage unit 144, an analog signal processor 150, a display unit 160, a digital signal processor (DSP) 170, and a manipulation unit 180.

The lens unit 110 is an interchangeable lens unit that can be changed according to a photographing environment, a subject, or the like. The lens unit 110 includes a diaphragm 111, a diaphragm driver 112, a zoom lens 113, a lens position detector 114, a lens controller 115, a focus lens 116, and a focus lens driver 117. The lens unit 110 has a zoom function. When the lens unit 110 does not have the zoom function, the lens unit 110 may not include the zoom lens 113.

A user can control the degree of opening of the diaphragm 111 in order to adjust the quantity of incident light.

The diaphragm driver 112 controls the degree of opening of the diaphragm 111, for example, an f-number, so that the user can perform operations of automatic focusing (AF), automatic exposure correction, focus changing, and controlling a depth of field.

The lens position detector 114 includes an encoding panel, in which a plurality of code patterns is formed at regular intervals in a direction of an optical axis within the range in which the zoom lens 113 moves, and an encoder brush, which slidably contacts the encode panel and is moved together with a lens adapter (not illustrated). The lens position detector 114 detects the moving distance of the zoom lens 113. Embodiments of the invention are not limited to this structure of the lens position detector 114, and any type of lens position detector that detects the position of the focus lens 116 may also be used.

The lens controller 115 may include a memory unit (not illustrated) including a read only memory (ROM) in which a control program is stored, or a flash memory in which data about the state of a lens is stored. Also, the lens controller 115 may further include a communication unit (not illustrated) for communication between the lens controller 115 and the digital signal processor (DSP) 170 of the digital photographing apparatus 100, wherein the communication unit (not illustrated) transmits the data about the state of the lens, such as a focal length of the lens unit 110, a diaphragm value, a focusing distance, and/or a the quantity of peripheral light, to the DSP 170, and receives drive-motion data of the focus lens 116 from the DSP 170, and also transmits data such as focal length information, a diaphragm value, or the like, which are obtained after an AF operation is performed, to the DSP 170 from the communication unit (not illustrated) of the lens controller 115. Also, the data about the state of the lens of the zoom lens 113 and/or the focus lens 116, or drive motion of the focus lens 116 transmitted from the DSP 170 may be stored in the memory unit (not illustrated) of the lens controller 115.

The focus lens driver 117 includes a helicoid screw and a gear (not illustrated) that rotates the helicoid screw, and moves only the focus lens 116 or both the focus lens 116 and the zoom lens 113 according to a control operation performed by the focus control unit 122 of the digital photographing apparatus 100.

Embodiments of the invention are not limited to the configuration of the lens unit 110 as described with reference to FIG. 1, and various types of lens units 110 may be used.

When the digital photographing apparatus 100 including the lens unit 110 is in a photographing mode and an electrical signal is applied to the DSP 170 by user's manipulation of the digital photographing apparatus 100, the DSP 170 detects the electrical signal in order to control the diaphragm control unit 121, the focus control unit 122, the mirror control unit 124, the shutter control unit 126, and/or the image pickup unit controller 132. Thus, the degree of opening of the diaphragm 111, positions of the zoom lens 113 and the focus lens 116, and sensitivity of the image pickup unit 130 can be controlled.

When a photographing operation is performed by the user, the mirror control unit 124 drives the mirror unit 123, and the shutter control unit 126 drives the shutter 125 so that light that has passed through the lens unit 110 can be incident on the image pickup unit 130.

When an optical signal that has passed through the lens unit 110 reaches a light-receiving surface of the image pickup unit 130, an image of the subject is formed thereon. The image pickup unit 130 may be a charge coupled device (CCD) or a complementary metal oxide semiconductor image sensor (CIS) that converts an optical signal into an electrical signal. The sensitivity of the image pickup unit 130 may be adjusted by the image pickup unit controller 132. The image pickup unit controller 132 may control the image pickup unit 130 according to a control signal that is automatically generated due to a real-time input image signal, or according to a control signal that is manually input by user's manipulation.

The exposure time of the image pickup unit 130 is adjusted by the shutter 125. Examples of the shutter 125 include a mechanical shutter that controls incidence of light by moving a shutter, and an electronic shutter that controls exposure by supplying an electrical signal to the image pickup unit 130.

The analog signal processor 150 performs noise reduction, gain control, waveform shaping, and analog-digital conversion on an analog signal supplied from the image pickup unit 130. The analog signal processor 150 may not be needed depending on characteristics of the image pickup unit 130.

A control signal is input to the manipulation unit 180 by the user. The manipulation unit 180 may include a shutter-release button for inputting a shutter-release signal used to perform a photographing operation by exposing the image pickup unit 130 for a predetermined amount of time, a power on button for inputting a control signal used to control turn on or off of the digital photographing apparatus 100, a wide-angle-zoom button and a telephotographic-zoom button for enlarging or reducing an image angle according to user's input, and various functional buttons for selecting at least one mode/function from the group consisting of a text input mode, a photographing mode, a reproduction mode, a white balance setting function, and an exposure setting function. The manipulation unit 180 may have various types of buttons, or may include a keyboard, a touch pad, a touch screen, a remote controller, or the like.

The program storage unit 140 stores a program of an operating system or an application system for driving the digital photographing apparatus 100. The buffer storage unit 142 temporarily stores data needed when an arithmetic operation is performed, or data obtained as a result of performing the arithmetic operation. The data storage unit 144 stores an image file including an image signal and various information, which are needed in the program.

The display unit 160 displays an operating state of the digital photographing apparatus 100 or information about an image photographed by the digital photographing apparatus 100. The display unit 160 may provide audio-visual information to the user. In order to provide the visual information, the display unit 160 may be a liquid crystal display (LCD) or an organic light emitting display (OLED) device.

The DSP 170 processes an input image signal, and controls the elements of the digital photographing apparatus 100 according to the input image signal or an external input signal. The DSP 170 performs image signal processing for improving the quality of an image, such as noise reduction in input image data, Gamma correction, color filter array interpolation, color matrix correction, color correction, and color enhancement. Also, the DSP 170 generates an image file by compressing image data that is generated during the image signal processing for improving the quality of an image, or restores the image data from the image file. The image data is compressed in a reversible or a non-reversible format. As an example of an appropriate format for compressing the image data, the image data can be compressed in a joint photographic experts group (JPEG) format such as JPEG 2000. The compressed data can be stored in the data storage unit 144.

The DSP 170 also performs unclearness processing, color processing, blur processing, edge emphasis processing, image interpretation processing, image recognition processing, image effect processing, etc. Image recognition processing among these processing may include face recognition or scene recognition processing.

The DSP 170 also performs display image signal processing so as to display the operating state of the digital photographing apparatus 100 or the information about an image photographed by the digital photographing apparatus 100 on the display unit 160. For example, the DSP 170 performs brightness level adjustment, color correction, contrast adjustment, contour emphasis adjustment, screen division processing, and character image generation and synthesis processing. The DSP 170 is connected to an external monitor and performs predetermined image signal processing so that a predetermined image can be displayed on the external monitor, and transmits the processed image data to the external monitor so as to display the predetermined image on the external monitor.

Also, the DSP 170 executes the program stored in the program storage unit 140, or includes an additional module to generate a control signal for use in automatic focusing, zoom changing, focus changing, and automatic exposure correction, to provide the control signal to the diaphragm control unit 121, the focus control unit 122, the mirror control unit 124, the shutter control unit 126, and the image pickup unit controller 132, and to control operations of the elements of the digital photographing apparatus 100 such as the shutter 125, a flash (not illustrated), etc.

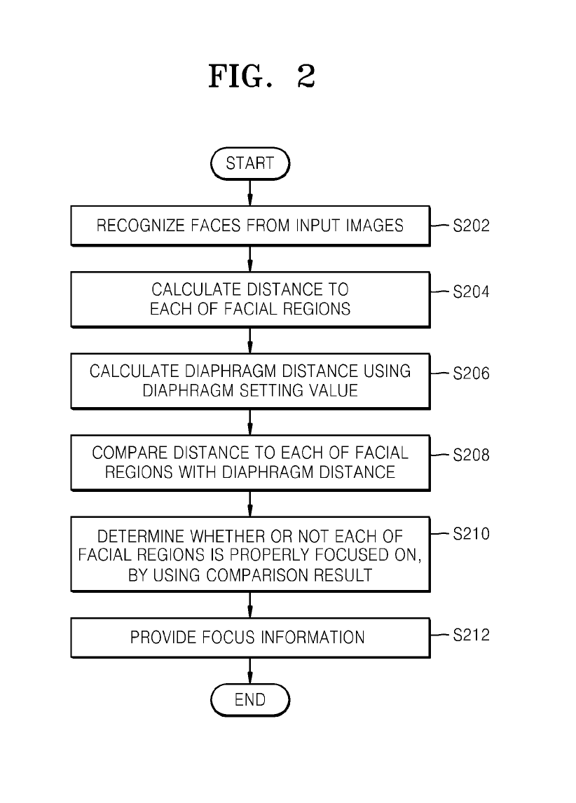

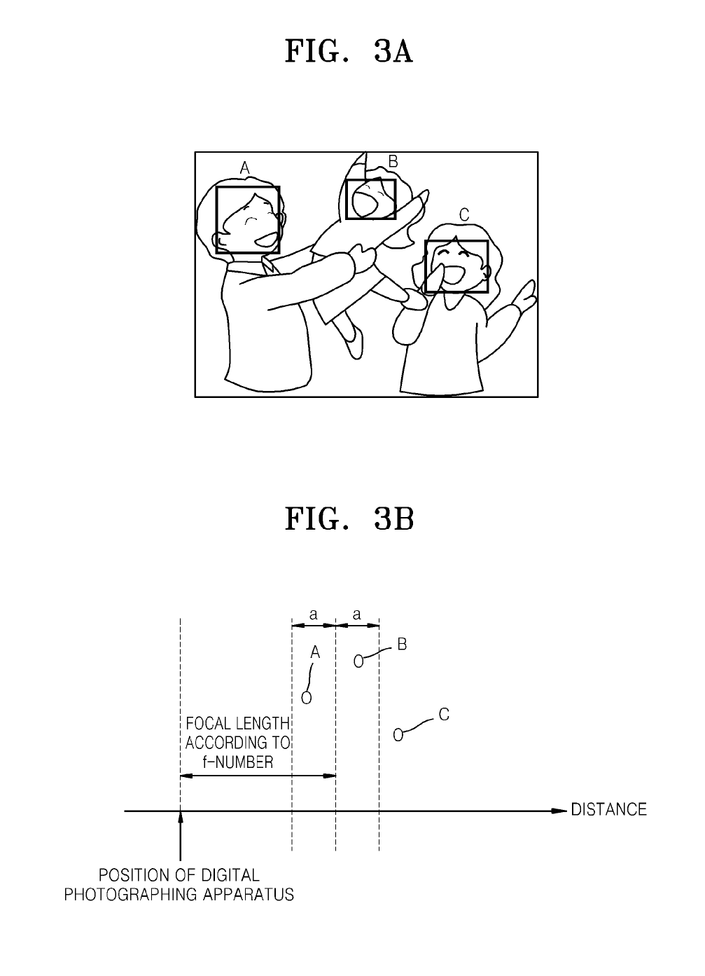

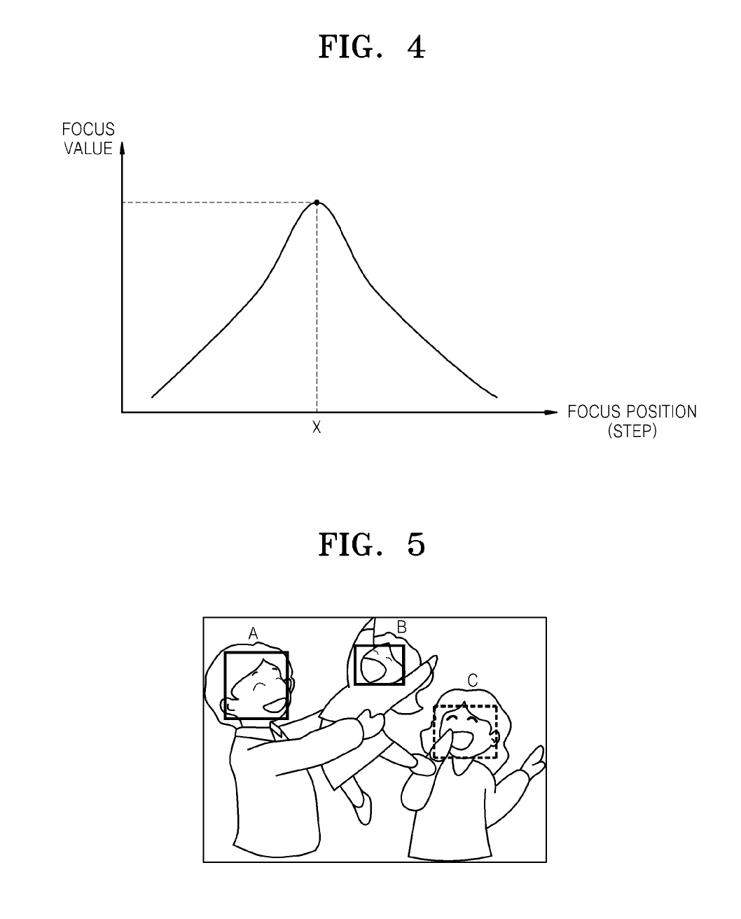

FIG. 2 is a flowchart illustrating a method of controlling the digital photographing apparatus shown in FIG. 1, according to an embodiment of the invention. FIG. 3A illustrates a screen displayed on a display unit of the digital photographing apparatus of FIG. 1, according to an embodiment of the invention, and FIG. 3B shows distances between the digital photographing apparatus of FIG. 1 and facial regions. Also, FIG. 4 is a graph of a focal position (step) versus a focus value, for explaining an operation of calculating a distance to a subject to be photographed, and FIG. 5 illustrates a screen displayed on the display unit of the digital photographing apparatus of FIG. 1, according to an embodiment of the invention.

Referring to FIG. 2, the method of controlling the digital photographing apparatus of FIG. 1, according to an embodiment includes operations of recognizing faces from input images, comparing a distance between regions A, B, and C of the recognized faces and the digital photographing apparatus 100 with a distance that is calculated from a diaphragm setting value, and displaying a face that is selected from among the recognized faces and that is properly in focus.

In detail, in Operation S202, facial regions A, B, and C are recognized from input images, wherein the recognized facial regions A, B, and C may be displayed on the display unit 160, as illustrated in FIG. 3A. Various face recognition algorithms such as an Adaboost algorithm, etc., may be used for face recognition. In the embodiment, a subject to be recognized from an input image is a human face; however, embodiments of the invention are not limited to this, and various types of subjects may be recognized from input images. Also, the input images may be live view input images.

If the facial regions A, B, and C are recognized from the input images, in Operation S204, distances from the digital photographing apparatus 100 to each of the facial regions A, B, and C are calculated. The calculated distances may be distances from the focus lens 116 to each of the facial regions A, B, and C. For example, the facial regions A, B, and C may be arranged as illustrated in FIG. 3B, and the distances from the digital photographing apparatus 100 to each of the facial regions A, B, and C are calculated.

The distances may be calculated, for example, from focus value data provided from an AF module. The AF module provides the focus value data generated at each focus position with respect to each of the facial regions A, B, and C. For example, data illustrated in FIG. 4 may be provided from the AF module by extracting a focus value from the facial region A while changing a focus position of the facial region A. If the maximum focus value of the facial region A is at a focus position x, the focus position x may be converted into data corresponding to the distance, thereby calculating the distance. In order to convert focus position into the distance, data needed in each operation when the zoom function is performed may be used. The distances to the facial regions B and C may also be calculated using the above-described method.

Embodiments of the invention are not limited to the above method of calculating the distance, and various methods of calculating the distance such as method of using infrared rays, laser, etc. may be used.

In Operation S206, a diaphragm distance is calculated from a diaphragm setting value. The diaphragm setting value may be an f-number. The f-number is calculated using Equation 1:

$$fnumbr = \frac{focal length}{diaphragm aperture} \qquad ( 1 )$$

Thus, a focal length may be calculated by multiplying the f-number by a diaphragm aperture. The diaphragm aperture is a previously-provided value. The focal length may be converted to have the same unit as the distance by using the f-number, thereby calculating the diaphragm distance. The diaphragm distance may be calculated when the user changes the diaphragm setting value.

After the distances to the facial regions A, B, and C and the diaphragm distance are calculated, in Operation S208, the distances to the facial regions A, B, and C and the diaphragm distance are respectively compared with each other by using Equation 2:

|distance−diaphragm distance|<first threshold value (2)

As expressed in Equation 2, in order to compare the distances to the facial regions A, B, and C and the diaphragm distance, a distance comparison result value of a difference between the distance and the diaphragm distance is calculated and compared with a first threshold value a. For example, it is determined whether or not the distance comparison result value is less than the first threshold value a. The first threshold value a may be set by a designer of the digital photographing apparatus 100, and may be a distance corresponding to one step or a half step by which the focus lens 116 moves. Also, the first threshold value a may vary according to the diaphragm setting value, i.e., the f-number.

Next, in Operation S210, it is determined whether or not each of the facial regions A, B, and C is properly in focus by using the comparison result. In other words, if the distance comparison result value is less than the first threshold value a, it is determined that each of the facial regions A, B, and C is properly in focus, and if the distance comparison result value is equal to or greater than the first threshold value a, it is determined that each of the facial regions A, B, and C is not properly in focus.

Referring to FIG. 3B, it is determined that the facial regions A and B are properly in focus within the first threshold value a based on a focal length according to the f-number, i.e., based on a position corresponding to the diaphragm distance, and it is determined that the facial region C that is farther away from the first threshold value a is not properly in focus based on the position corresponding to the diaphragm distance.

After focus information that indicates whether or not each of the facial regions A, B, and C is properly in focus is determined, in Operation S212, the facial regions A and B that are properly in focus and the facial region C that is not properly in focus are displayed differently, thereby providing the focus information to the user. For example, as illustrated in FIG. 5, the facial regions A and B that are properly in focus and the facial region C that is not properly in focus are displayed on the display unit 160 by using different lines (solid lines and a dotted line) so that the focus information can be provided to the user.

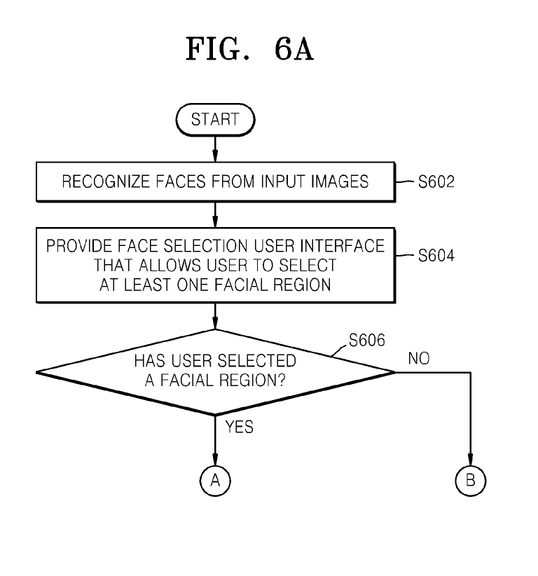

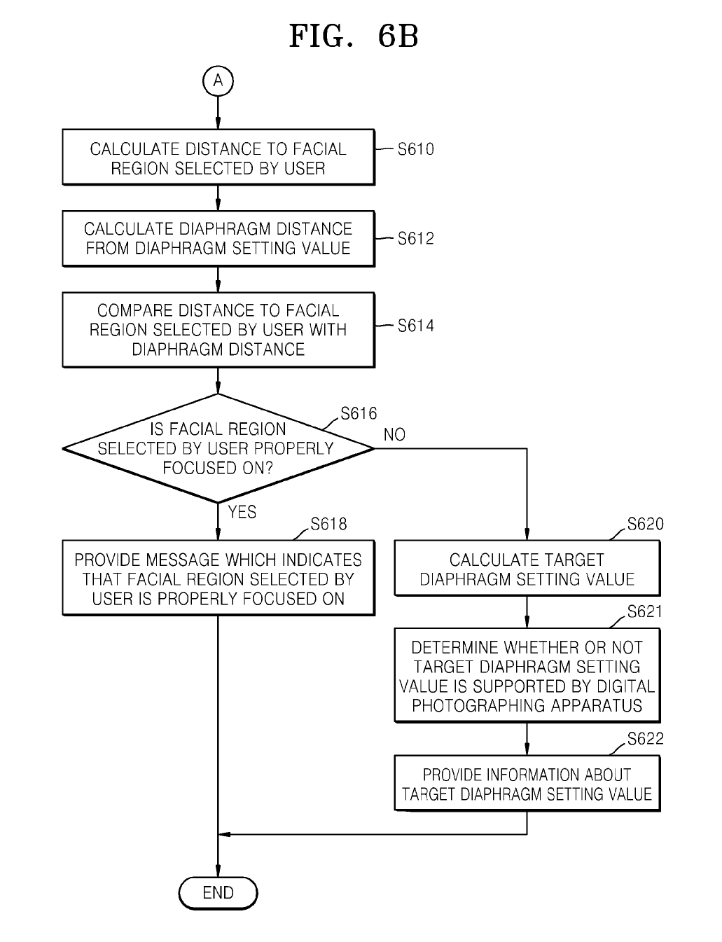

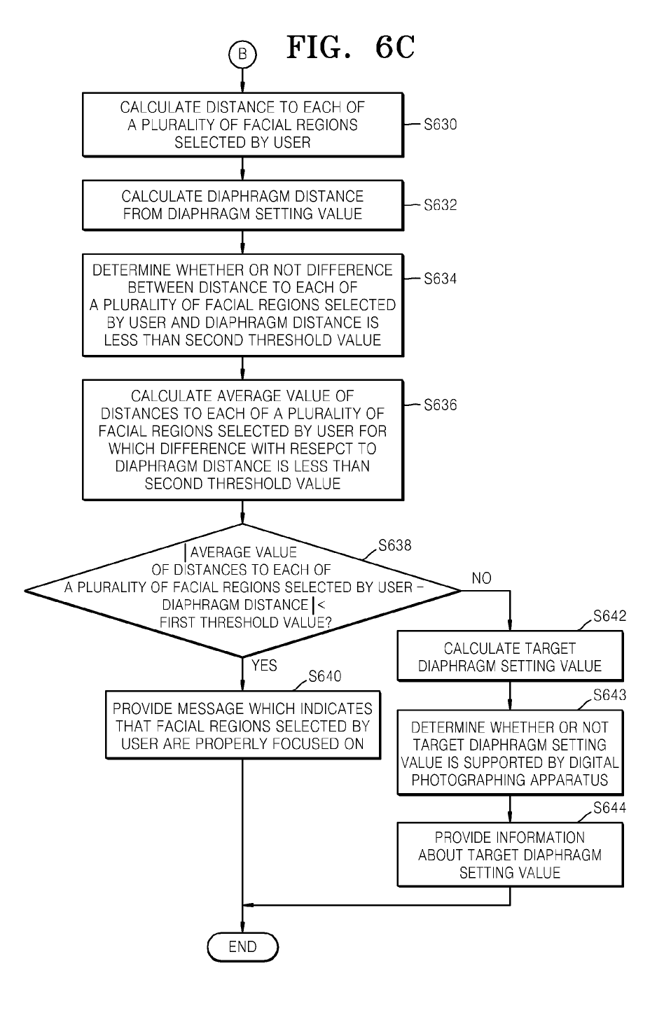

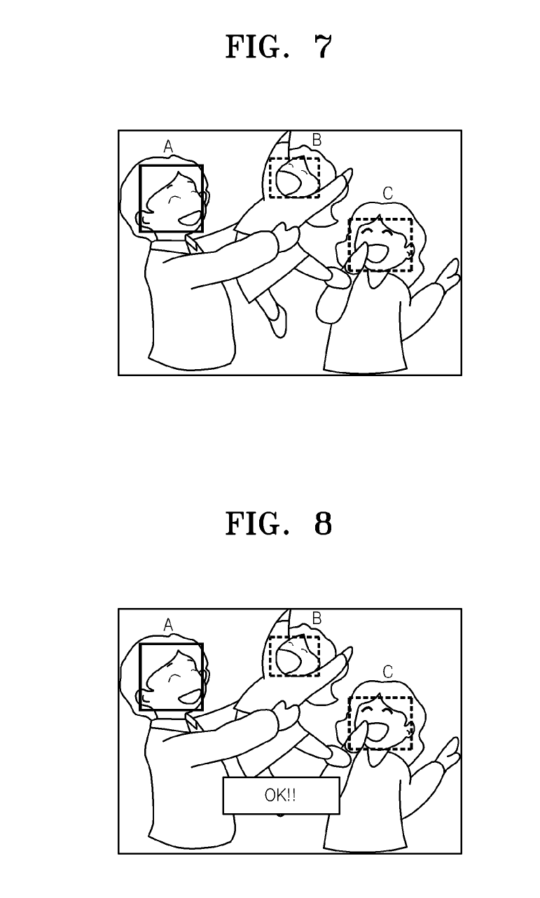

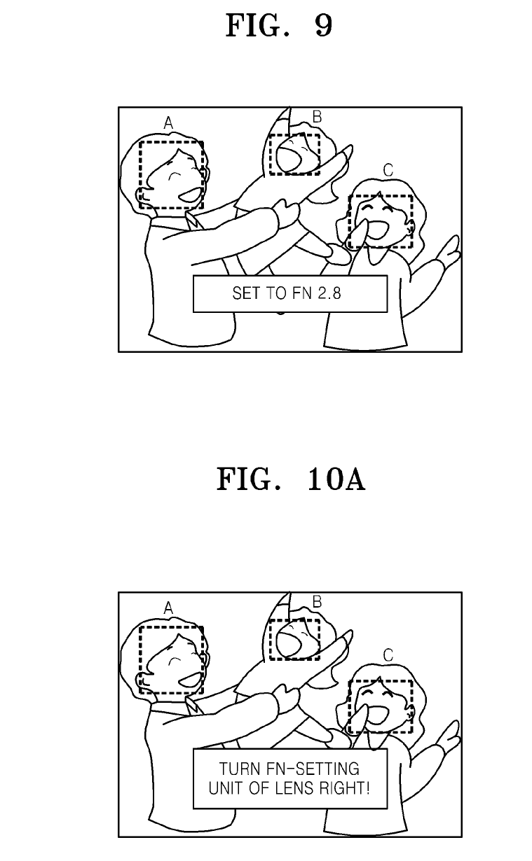

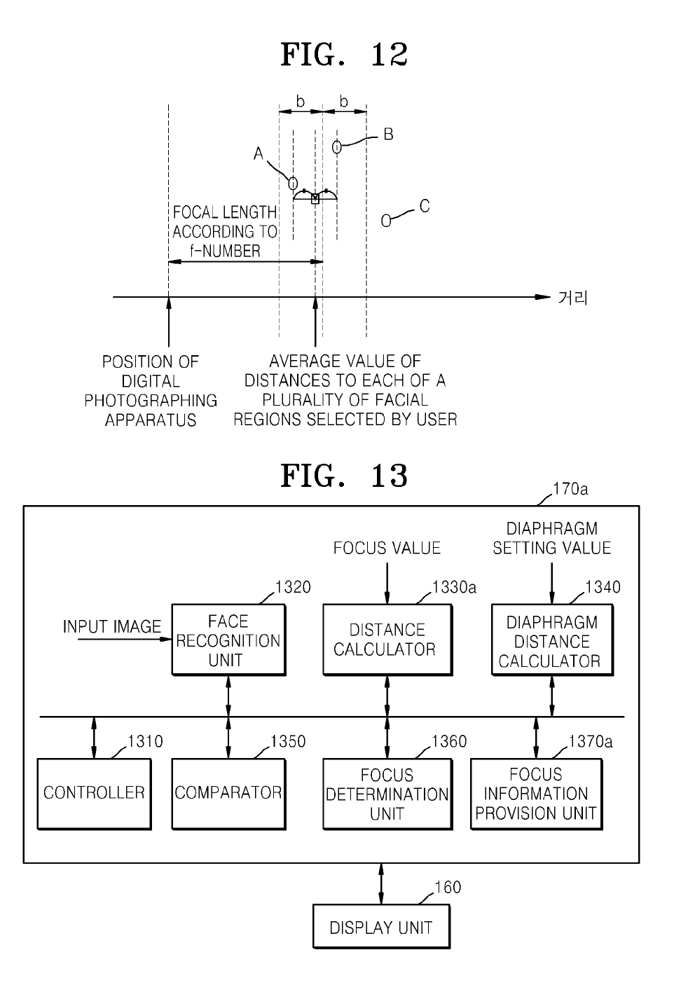

FIGS. 6A through 6C are flowcharts illustrating a method of controlling the digital photographing apparatus 100 of FIG. 1, according to another embodiment of the invention. FIGS. 7 through 9, FIGS. 10A through 10D, and FIG. 11 respectively illustrate screens displayed on the display unit 160 of the digital photographing apparatus 100 of FIG. 1 when the method of controlling a digital photographing apparatus illustrated in FIGS. 6A through 6C is performed, and FIG. 12 shows distances between the digital photographing apparatus 100 of FIG. 1 and each of the facial regions A, B, and C of FIG. 1, for explaining an operation of calculating an average distance.

Referring to FIGS. 6A through 6C, the method of controlling the digital photographing apparatus of FIG. 1, according to an embodiment, includes operations of comparing distances to a subject and diaphragm distance, which are information about a subject selected by the user, and providing information about a target diaphragm setting value to be set so as to properly focus on the subject selected by the user.

In detail, in Operation S602, if images are input to the digital photographing apparatus 100, facial regions A, B, and C are recognized from the input images.

After the facial regions A, B, and C are recognized from the input images, in Operation S604, a face selection user interface that allows the user to select at least one from among the recognized facial regions A, B, and C is provided. The face selection user interface allows screens on which the recognized facial regions A, B, and C, as illustrated in FIG. 3A, are displayed to be provided to the user. If a control signal used to select one from among the facial regions A, B, and C is input by the manipulation unit 180 manipulated by the user, the selected facial region A may be displayed differently, as illustrated in FIG. 7. The control signal used to select one from among the facial regions A, B, and C may be input by a touch screen, a keyboard, etc., which may be included in the manipulation unit 180. In this case, the face selection user interface may be limited so that the user can select only one facial region. As an alternative, the face selection user interface may allow the user to select one or more facial regions.

After the user completes facial region selection, in Operation S606, it is determined whether or not the user has selected one from among the facial regions A, B, and C.

If the user has selected only a facial region from among the facial regions A, B, and C, in Operation S610, the distance to the facial region selected by the user is calculated, and in Operation S612, the diaphragm distance is calculated from the diaphragm setting value, e.g., the f-number.

After the distance to the facial region selected by the user and the diaphragm distance are calculated, in Operation S614, the distance to the facial region selected by the user and the diaphragm distance are compared with each other, and in Operation S616, it is determined whether or not the facial region selected by the user is properly in focus. If a distance comparison value as the result of determining by using Equation 2 is less than the first threshold value a, it may be determined that the facial region selected by the user is properly in focus, and if the distance comparison value as the result of determining by using Equation 2 is equal to or greater than the first threshold value a, it may be determined that the facial region selected by the user is not properly in focus, as described previously.

If the facial region selected by the user is properly in focus, in Operation S618, a message which indicates that the facial region selected by the user is properly in focus is provided. For example, the facial region A selected by the user is displayed, as illustrated in FIG. 8, and the message “OK!!” which indicates that the facial region A selected by the user is properly in focus may be displayed on the display unit 160.

If the facial region selected by the user is not properly in focus, in Operation S620, the target diaphragm setting value to be set so as to properly focus on the subject selected by the user is calculated. The target diaphragm setting value may be calculated by calculating the diaphragm setting value, i.e., the f-number, which corresponds to the closest focal length to the distance to the subject.

After the target diaphragm setting value is calculated, in Operation S621, it is determined whether or not the target diaphragm setting value can be supported by the digital photographing apparatus 100.

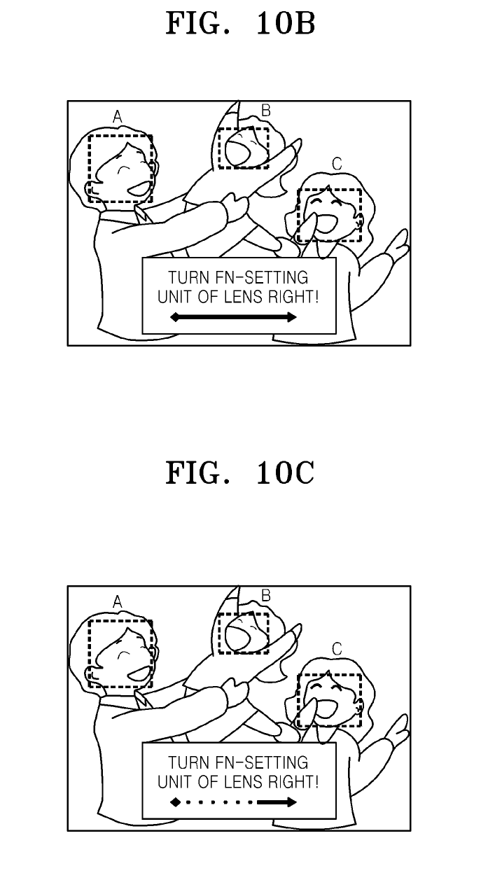

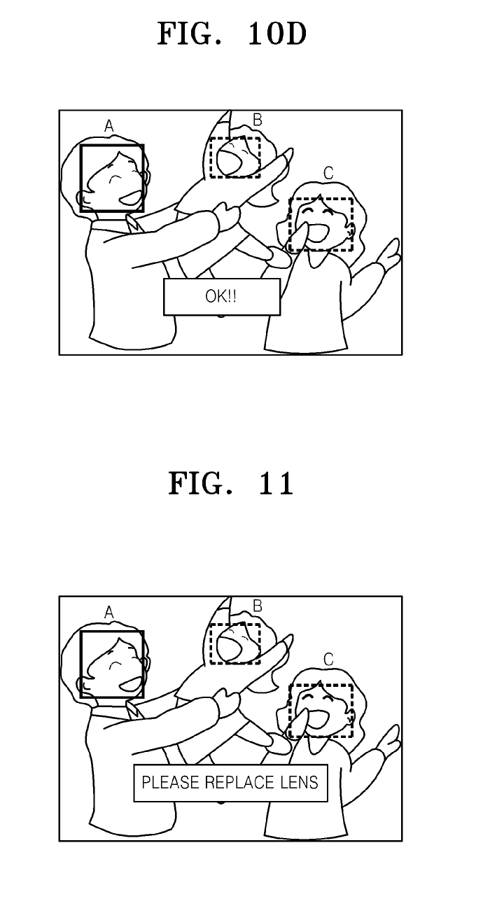

In Operation S622, information about the target diaphragm setting value is provided. In detail, the target diaphragm setting value itself is displayed, or how to operate the digital photographing apparatus 100 is displayed so as to adjust a diaphragm setting value by using the target diaphragm setting value, or a message which indicates that the target diaphragm setting value is not supported by the digital photographing apparatus 100 is displayed, thereby providing the information about the target diaphragm setting value to the user. For example, the target diaphragm setting value may be displayed on the display unit 160, as illustrated in FIG. 8. Alternatively, how to operate the digital photographing apparatus 100 so as to adjust the diaphragm setting value by using the target diaphragm setting value is indicated as illustrated in FIGS. 10A through 10C, and if the diaphragm setting value is set to the target diaphragm setting value, the message “OK!!” which indicates that the facial region A selected by the user is properly in focus may be provided to the user, as illustrated in FIG. 10D. In this case, as illustrated in FIGS. 10B and 10C, how to operate the digital photographing apparatus 100 may be provided to the user in response to the diaphragm setting value set by the user in real-time. If the target diaphragm setting value is not supported by the digital photographing apparatus 100, a message that instructs the user to replace a lens may be provided to the user, as illustrated in FIG. 11.

If the user has selected a plurality of facial regions from among the facial regions A, B, and C, in Operation S630, the distances to each of the plurality of facial regions selected by the user are calculated, and in Operation S632, the diaphragm distance is calculated from the diaphragm setting value, e.g., from the f-number.

After the distances to each of the plurality of facial regions selected by the user and the diaphragm distance are calculated, in Operation S634, it is determined whether or not a distance between the distance to each of the plurality of facial regions selected by the user and the diaphragm distance is less than a second threshold value b, and in Operation S636, an average distance for the facial regions for which the difference between the distances thereto and the diaphragm distance is less than the second threshold value b is calculated.

Referring to FIG. 12, if the user has selected the facial regions A, B, and C, the facial regions within the second threshold value b, i.e., the facial regions A and B are extracted based on a focal length according to an f-number, i.e., based on a distance corresponding to the diaphragm distance, and the average distance about the facial regions A and B is calculated. After the average distance is calculated in the above-mentioned manner, the method illustrated in FIGS. 6A through 6C proceeds to the next operations.

The second threshold value b may be set by a manufacturer of the digital photographing apparatus 100 of FIG. 1 and may vary according to the diaphragm setting value, i.e., the f-number.

After the average distance is calculated, in Operation S638, a distance comparison result value that corresponds to a difference between the average distance and the diaphragm distance is calculated, and the distance comparison result value is compared with the first threshold value a to determine whether or not the facial regions A, B, and C that are selected by the user are properly in focus.

If the distance comparison result value is less than the first threshold value a, in Operation S640, the message which indicates that the facial regions A, B, and C that are selected by the user are properly in focus may be displayed on the display unit 160, as illustrated in FIG. 8.

If the distance comparison result value is equal to or greater than the first threshold value a, in Operation S642, the target diaphragm setting value is calculated based on the average distance, and in Operation S643, it is determined whether or not the target diaphragm setting value is supported by the digital photographing apparatus 100. In Operation S644, information about the target diaphragm setting value is provided to the user by displaying the target diaphragm setting value, by displaying how to operate the digital photographing apparatus 100 so as to adjust the diaphragm setting value by using the target diaphragm setting value, or by displaying a message which indicates that the target diaphragm setting value is not supported by the digital photographing apparatus 100.

According to another embodiment of the invention, the subject that is properly in focus may be directly chosen by the user. To this end, the method of controlling the digital photographing apparatus 100 of FIG. 1 as shown in FIGS. 6A through 6C may include providing a subject region designation user interface that allows the user to designate an arbitrary region of the input images as the subject. The user may designate at least one subject region by using the subject region designation user interface by using the touch screen, the keyboard, etc., which may be included in the manipulation unit 180. In the embodiment, the distance to at least one subject region that is designated by the user is calculated.

FIG. 13 is a block diagram of a digital signal processor (DSP) 170a and the display unit 160 of the digital photographing apparatus 100 of FIG. 1, according to an embodiment of the invention. Referring to FIG. 13, the digital signal processor (DSP) 170a may include a controller 1310, a face recognition unit 1320, a distance calculator 1330a, a diaphragm distance calculator 1340, a comparator 1350, a focus determination unit 1360, and a focus information provision unit 1370a.

The controller 1310 controls operations of the digital photographing apparatus 100. For example, the controller 1310 generates a control signal to control automatic focusing, zoom changing, focus changing, and automatic exposure correction, provides the control signal to the diaphragm control unit 121, the focus control unit 122, the mirror control unit 124, the shutter control unit 126, and the image pickup unit controller 132, and controls operations of the elements of the digital photographing apparatus 100 such as the shutter 125, a flash (not illustrated), etc.

The face recognition unit 1320 recognizes faces from input images. Regions A, B, and C of the recognized faces may be displayed on the display unit 160, as illustrated in FIG. 3A. Various face recognition algorithms such as an Adaboost algorithm, etc., may be used for face recognition.

The distance calculator 1330a calculates the distance to each of the facial regions A, B, and C recognized by the face recognition unit 1320. The distance may be calculated from focus value data which are provided from an AF module. However, a method of calculating the distance is not limited to this, and various methods of calculating the distance such as using infrared rays, laser, etc., may be used.

The diaphragm distance calculator 1340 calculates the diaphragm distance from a diaphragm setting value. The diaphragm setting value may be an f-number. The diaphragm distance calculator 1340 may calculate the diaphragm distance by calculating the focal length by multiplying the f-number by the diaphragm aperture by using Equation 1.

The diaphragm distance may be calculated when the user changes the diaphragm setting value.

The comparator 1350 calculates a distance comparison result value that is a difference between the distance to each of the facial regions A, B, and C and the diaphragm distance, and determines whether or not the distance comparison result value is less than the first threshold value a.

The focus determination unit 1360 determines whether or not each of the facial regions A, B, and C is properly in focus according to the result of comparison performed by the comparator 1350. In other words, if the distance comparison result value is less than the first threshold value a, it is determined that each of the facial regions A, B, and C is properly in focus, and if the distance comparison result value is equal to or greater than the first threshold value a, it is determined that each of the facial regions A, B, and C is not properly in focus.

The focus information provision unit 1370a provides focus information by differently displaying a facial region that is properly in focus, and a facial region that is not properly in focus. For example, the focus information provision unit 1370a may differently display on the display unit 160 the facial regions A and B that are properly in focus and the facial region C that is not properly in focus, so as to provide the focus information to the user.

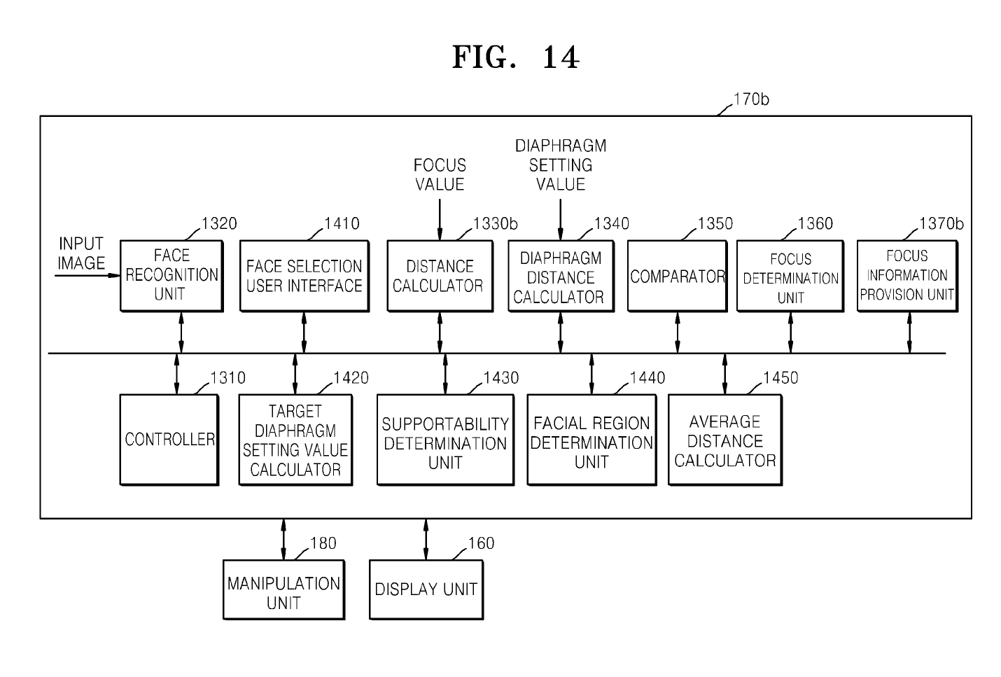

FIG. 14 is a block diagram of a DSP 170b, the manipulation unit 180, and the display unit 160 of the digital photographing apparatus 100 of FIG. 1, according to another embodiment of the invention. Referring to FIG. 14, the DSP 170b may further include a face selection user interface 1410, a target diaphragm setting value calculator 1420, a supportability determination unit 1430, a plurality-of-facial regions determination unit 1440, and an average subject distance calculator 1450.

The face selection user interface 1410 allows the user to select at least one from among the facial regions A, B, and C recognized by the face recognition unit 1320. The face selection user interface 1410 provides to the display unit 160 screens on which the facial regions A, B, and C are displayed, as illustrated in FIG. 3, and if the control signal used to select a face is input by the user via the manipulation unit 180, a selected face (the facial region A) may be displayed differently as illustrated in FIG. 7. The control signal used to select the face may be input by using a touch screen, a keyboard, etc., which may be included in the manipulation unit 180. In this case, the face selection user interface 1410 may be limited to select one facial region from among the facial regions A, B, and C recognized by the face recognition unit 1320. As an alternative, the face selection user interface 1410 may allow the user to select one or more facial regions from among the facial regions A, B, and C recognized by the face recognition unit 1320.

After the user completes selection of the facial regions A, B, and C, a distance calculator 1330b calculates distances to the facial regions selected by the user.

If the user has selected a plurality of facial regions, the plurality-of-facial regions determination unit 1440 determines whether or not a distance between distances to each of the facial regions A, B, and C and the diaphragm distance is less than the second threshold value b.

Then, the average distance calculator 1450 calculates an average distance for cases when the distance between distances to each of the facial regions A, B, and C and the diaphragm distance is less than the second threshold value b as the result of determination performed by the plurality-of-facial regions determination unit 1440.

In an embodiment of the invention, if the user has selected only one subject (facial region), the comparator 1350 calculates a difference between the distance to the subject selected by the user and the diaphragm distance, and if the user has selected a plurality of subjects (facial regions), the comparator 1350 calculates a difference between the average value of the distances to the selected subjects and the diaphragm distance.

If the subject or the plurality of facial regions selected by the user are not in focus, the target diaphragm setting value calculator 1420 calculates a target diaphragm setting value so as to focus on the facial region(s) selected by the user. The target diaphragm setting value may be calculated by obtaining the diaphragm setting value (i.e., the f-number) with which the closest focus length to the distance to the selected facial region(s) can be obtained.

After the target diaphragm setting value is calculated, the supportability determination unit 1430 determines whether or not the target diaphragm setting value is supported by the digital photographing apparatus 100.

If the focus information determined by the focus determination unit 1360 is provided and the target diaphragm setting value is calculated by the target diaphragm setting value calculator 1420, a focus information provision unit 1370b provides information about the target diaphragm setting value. In particular, the target diaphragm setting value may be displayed, or how to operate the digital photographing apparatus 100 may be displayed so as to adjust a diaphragm setting value by using the target diaphragm setting value, or a message which indicates that the target diaphragm setting value is not supported by the digital photographing apparatus 100 may be displayed, thereby providing the information about the target diaphragm setting value. For example, the target diaphragm setting value may be displayed on the display unit 160, as illustrated in FIG. 8. Alternatively, how to operate the digital photographing apparatus 100 so as to adjust the diaphragm setting value by using the target diaphragm setting value is indicated, as illustrated in FIGS. 10A through 10C, and if the diaphragm setting value is set to the target diaphragm setting value, the message “OK!!” which indicates that the facial region A selected by the user is properly in focus may be provided to the user, as illustrated in FIG. 10D. If the target diaphragm setting value is not supported by the digital photographing apparatus 100, a message that instructs the user to replace a lens may be provided to the user, as illustrated in FIG. 11.

According to another embodiment of the invention, a subject to be in focus may be chosen by the user. To this end, the DSP 170a or 170b shown in FIG. 13 or 14 may further include a subject region designation user interface (not shown) that allows the user to designate an arbitrary region of the input images as the subject. The user may designate at least one subject region by using the subject region designation user interface by using the touch screen, the keyboard, etc., which may be included in the manipulation unit 180. In an embodiment of the invention, the distance calculator 1330a or 1330b shown in FIG. 13 or 14 may calculate the distance to the at least one subject region that is chosen by the user.

In addition, other embodiments of the invention can also be implemented through computer readable code/instructions in/on a medium, e.g., a computer readable medium, to control at least one processing element to implement any of the above described embodiments. The medium can correspond to any medium/media permitting the storage and/or transmission of the computer readable code.

When it is read from the computer readable medium and is executed by the DSP 170a or 170b shown in FIG. 13 or 14, the computer readable code executes operations of the method of controlling the digital photographing apparatus illustrated in FIGS. 6A through 6C. The computer readable code may be implemented with various programming languages. A functional program, a code, and code segments that are used to realize embodiments of the invention may be easily programmed by one of ordinary skill in the art.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Furthermore, the media may also be a distributed network, so that the computer readable code is stored/transferred and executed in a distributed fashion.

According to an embodiment of the invention, a user refers to information about a focused subject and an unfocused subject at a currently-set diaphragm setting value when setting a photographing setting value during a photographing operation so that the user can obtain clearer photo and photograph conveniently.

Also, according to an embodiment of the invention, the diaphragm setting value to be set so as to photograph a desired subject, or a guide to set a diaphragm is provided so that the user can more conveniently set the diaphragm setting value and user's conveniences can be increased.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

Embodiments of the invention may be described in terms of functional block components and various processing steps. Such functional blocks may be realized by any number of hardware and/or software components configured to perform the specified functions. For example, an embodiment of the invention may employ various integrated circuit components, e.g., memory elements, processing elements, logic elements, look-up tables, and the like, which may carry out a variety of functions under the control of one or more microprocessors or other control devices. Similarly, where the elements of an embodiment of the invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, an embodiment of the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing embodiments of the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

Numerous modifications and adaptations will be readily apparent to those skilled in this art without departing from the spirit and scope of the embodiments of the invention.

What is claimed is:

1. A method of controlling a digital photographing apparatus, the method comprising:
calculating a distance from the digital photographing apparatus to at least one of a plurality of subject regions to be photographed;
calculating a diaphragm distance by using a focal length calculated based on a diaphragm setting value that indicates a degree of opening of a diaphragm;
comparing the distance from the digital photographing apparatus to at least one of a plurality of subject regions with the diaphragm distance;
determining whether or not the at least one subject region is in focus, according to a result of the comparing; and
providing focus information that indicates whether or not the at least one subject region is in focus.

2. The method of claim 1, wherein the calculating of the distance from the digital photographing apparatus to at least one of a plurality of subject regions comprises determining a focus position for a maximum focus value of the at least one subject region.

3. The method of claim 1, wherein the diaphragm setting value is an f-number, and the focal length is calculated by multiplying the f-number by a diaphragm aperture.

4. The method of claim 1, wherein: the calculating of the diaphragm distance is performed when the diaphragm setting value is changed by a user's input.

5. The method of claim 1, wherein:
the comparing of the distance from the digital photographing apparatus to at least one of a plurality of subject regions with the diaphragm distance comprises determining whether or not a distance comparison result value of a difference between the distance from the digital photographing apparatus to at least one of a plurality of subject regions and the diaphragm distance is less than a first threshold value; and
the determining of whether or not the at least one subject region is in focus comprises:
if the distance comparison result value is less than the first threshold value, determining that the at least one subject region is in focus; and
if the distance comparison result value is equal to or greater than the first threshold value, determining that the at least one subject region is not in focus.

6. The method of claim 1, further comprising recognizing a face from an input image, wherein the at least one subject region is a region of the face, and the providing of the focus information comprises displaying differently a subject region that is in focus and a subject region that is not in focus.

7. The method of claim 1, further comprising:
recognizing at least one of a plurality of faces from input images and displaying at least one facial region; and
providing a user interface that allows a user to select the at least one facial region,
wherein the at least one subject region is a facial region that is selected by the user.

8. The method of claim 7, further comprising:
if the user has selected a facial region and the facial region selected by the user is not in focus, calculating a target diaphragm setting value as the diaphragm setting value to be set to focus the facial region selected by the user,
wherein the providing of the focus information further comprises:
if the facial region selected by the user is in focus, providing a message which indicates that the facial region selected by the user is in focus; and
if the facial region selected by the user is not in focus, providing information about the target diaphragm setting value.

9. The method of claim 8, wherein the information about the target diaphragm setting value comprises one of the target diaphragm setting value, how to operate the digital photographing apparatus for setting the target diaphragm setting value, and a combination thereof.

10. The method of claim 9, further comprising determining whether or not the target diaphragm setting value is supported by the digital photographing apparatus, wherein the providing of the focus information comprises, if the target diaphragm setting value is not supported by the digital photographing apparatus, providing one of a message which indicates that photographing of a facial region selected by the user is not supported, a message which instructs the user to replace a lens of the digital photographing apparatus, and a combination thereof.

11. The method of claim 7, wherein, before the comparing of the distance from the digital photographing apparatus to at least one of a plurality of subject regions with the diaphragm distance, the method further comprises, if the user has selected a plurality of facial regions:
determining whether or not a difference between the distance from the digital photographing apparatus to each of the plurality of subject regions and the diaphragm distance is less than a second threshold value; and
calculating an average distance of the distances from the digital photographing apparatus to each of the plurality of subject regions for which the difference with respect to the diaphragm distance is less than the second threshold value,
wherein the comparing of the distance from the digital photographing apparatus to at least one of the plurality of subject regions with the diaphragm distance further comprises comparing the average distance with the diaphragm distance.

12. The method of claim 11, further comprising:
if the plurality of facial regions selected by the user are not properly in focus, calculating a target diaphragm setting value as the diaphragm setting value to be set to focus the facial regions selected by the user based on the average distance,
wherein the providing of the focus information comprises:
if the facial regions selected by the user are in focus, providing a message which indicates that the facial regions selected by the user are in focus, based on the average distance; and
if the facial regions selected by the user are not in focus, providing information about the target diaphragm setting value based on the average distance.

13. The method of claim 12, wherein the information about the target diaphragm setting value comprises one of the target diaphragm setting value, how to operate the digital photographing apparatus for setting the target diaphragm setting value, and a combination thereof.

14. The method of claim 13, further comprising determining whether or not the target diaphragm setting value is supported by the digital photographing apparatus, wherein the providing of the focus information comprises, if the target diaphragm setting value is not supported by the digital photographing apparatus, providing one of a message which indicates that the target diaphragm setting value cannot be supported by the digital photographing apparatus, a message which instructs the user to replace a lens of the digital photographing apparatus, and a combination thereof.

15. The method of claim 1, further comprising providing a subject region designation user interface that allows the user to designate an arbitrary region of the input images as a subject, wherein the at least one subject region is an arbitrary subject region designated by the user.

16. A digital photographing apparatus comprising:
a distance calculator that calculates a distance from the digital photographing apparatus to at least one of a plurality of subject regions to be photographed;
a diaphragm distance calculator that calculates a diaphragm distance by using a focal length calculated based on a diaphragm setting value that indicates a degree of opening of a diaphragm;
a comparator that compares the distance from the digital photographing apparatus to at least one of a plurality of subject regions to be photographed with the diaphragm distance and that calculates a distance comparison result value of a difference between the distance from the digital photographing apparatus to at least one of a plurality of subject regions to be photographed and the diaphragm distance;
a focus determination unit that determines whether or not the at least one subject region is in focus; and
a focus information provision unit that provides focus information that indicates whether or not the at least one subject region is in focus.

17. The apparatus of claim 16, wherein the comparator determines whether or not the distance comparison result value is less than a first threshold value, and the focus determination unit, if the distance comparison result value is less than the first threshold value, determines that the at least one subject region is in focus, and if the distance comparison result value is equal to or greater than the first threshold value, determines that the at least one subject region is not in focus.

18. The apparatus of claim 16, further comprising:
a face recognition unit that recognizes at least one of a plurality of faces from input images and that displays at least one facial region; and
a face selection user interface that provides a user interface that allows a user to select the at least one facial region,
wherein the at least one subject region is a facial region that is selected by the user.

19. The apparatus of claim 18, further comprising a target diaphragm setting value calculator that calculates, if the user has selected a facial region and the facial region selected by the user is not in focus, a target diaphragm setting value as the diaphragm setting value to be set to properly focus on the facial region selected by the user, wherein the focus information provision unit, if the facial region selected by the user is in focus, provides a message which indicates that the facial region selected by the user is in focus, and if the facial region selected by the user is not in focus, provides information about the target diaphragm setting value.

20. The apparatus of claim 19, wherein the information about the target diaphragm setting value comprises one of the target diaphragm setting value, how to operate the digital photographing apparatus for setting the target diaphragm setting value, and a combination thereof.

21. The apparatus of claim 20, further comprising a supportability determination unit that determines whether or not the target diaphragm setting value is supported by the digital photographing apparatus, wherein the focus information provision unit provides one of a message which indicates that photographing of a facial region selected by the user is not supported, a message which instructs the user to replace a lens of the digital photographing apparatus, and a combination thereof, if the target diaphragm setting value is not supported by the digital photographing apparatus.

22. The apparatus of claim 18, further comprising:
a facial region determination unit that determines, if the user has selected a plurality of facial regions, whether or not a difference between the distances from the digital photographing apparatus to the plurality of subject regions, and the diaphragm distance is less than a second threshold value; and
an average distance calculator that calculates, if the user has selected the plurality of facial regions, an average distance of the distances from the digital photographing apparatus to the plurality of subject regions for which the difference with respect to the diaphragm distance is less than the second threshold value,
wherein the comparator compares, if the user has selected the plurality of facial regions, the average distance with the diaphragm distance.

23. The apparatus of claim 16, further comprising a subject region designation user interface that allows the user to designate an arbitrary region of the input images as a subject, wherein the at least one subject region is an arbitrary subject region designated by the user.

24. A non-transitory computer readable program product, comprising a computer usable medium having a computer readable program code embodied therein, the computer readable program code adapted to be executed to implement a method of controlling a digital processing apparatus, the method comprising:
calculating a distance from a digital photographing apparatus to at least one of a plurality of subject regions;
calculating a diaphragm distance by using a focal length calculated based on a diaphragm setting value that indicates a degree of opening of a diaphragm;
comparing the distance from a digital photographing apparatus to at least one of a plurality of subject regions with the diaphragm distance;
determining whether or not the at least one subject region is in focus, according to a result of the comparing; and
providing focus information that indicates whether or not the at least one subject region is in focus.
